(19) United States
(12) Patent Application Publication
(10) Pub. No.: US 2026/0331707 A1
(43) Pub. Date: Oct. 22, 2026

(54) POWER STORAGE DEVICE AND METHOD OF MANUFACTURING SAME

(71) Applicant: Prime Planet Energy & Solutions, Inc., Tokyo (JP)

(72) Inventors: Daichi TAKEMOTO, Kobe-shi (JP); Tomonori MAEDA, Kobe-shi (JP)

(21) Appl. No.: 19/651,794

(22) Filed: Apr. 20, 2026

(30) Foreign Application Priority Data
Apr. 22, 2025 (JP) 2025-070278

(51) Int. Cl. H01M 50/474; H01M 10/04; H01M 50/103; H01M 50/15; H01M 50/466; H01M 50/531

(52) U.S. Cl. CPC H01M 50/474; H01M 10/0459; H01M 10/049; H01M 50/103; H01M 50/15; H01M 50/466; H01M 50/531

(57) ABSTRACT

In the present power storage device, a spacer is provided between a sealing plate and an electrode assembly, the spacer has a pair of side walls extending toward the electrode assembly and disposed at a predetermined interval, at least an outermost layer separator of the separator has an extension portion extending from an end portion of each of a negative electrode and a positive electrode toward the spacer, and the extension portion is disposed on an inner side of each of the side walls or is fixed to the side wall. According to the present power storage device, when inserting the electrode assembly into a case main body, a step due to bending of end portions of the separator can be suppressed from being formed at an end portion of the electrode assembly.

### CROSS REFERENCE TO RELATED APPLICATIONS

This nonprovisional application is based on Japanese Patent Application No. 2025-070278 filed on Apr. 22, 2025 with the Japan Patent Office, the entire contents of which are hereby incorporated by reference.

### BACKGROUND OF THE INVENTION

### Field of the Invention

The present technology relates to a power storage device and a method of manufacturing the power storage device.

### Description of the Background Art

Each of Japanese Patent Laying-Open No. 2024-176302 and Japanese Patent Laying-Open No. 2024-176297 disclose a technology relating to a secondary battery and a method of manufacturing the secondary battery. Specifically, a manufacturing process is disclosed in which an electrode assembly including a positive electrode plate and a negative electrode plate separated by a separator is covered with an insulating sheet, and the electrode assembly covered with the insulating sheet is inserted into a case main body having a tubular shape.

### SUMMARY OF THE INVENTION

At the both end portions (front side and rear side when inserted into the case main body) of the electrode assembly, the end portions of the separator are exposed from the end portions of the negative electrode and the positive electrode. When the electrode assembly is inserted into the case main body having the tubular shape in this state, bending may occur at the end portions of the separator.

In particular, it has been found that in a configuration in which a spacer is disposed between a sealing plate and the electrode assembly on the side of the opening end of the case main body, the end portions of the separator and the spacer are pushed against one another to cause bending at the end portions of the separator due to pushing pressure at the time of inserting the electrode assembly into the case main body, with the result that layers of the separator thus bent cause formation of a step such as a crease.

Further, when this step reaches an end portion of the electrode assembly, the step faces an active material layer provided on a surface of each of the negative electrode and positive electrode of the electrode assembly. It has been found that there is such a problem that when the step reaches the surface facing the active material layer, precipitation of Li occurs on the surface of each of the positive electrode plate and the negative electrode plate due to the step as the secondary battery is charged and discharged.

This problem is not limited to the secondary battery, and the same applies to a power storage device that can be charged and discharged.

The present technology has been made to solve the above problem, and has an object to provide a power storage device and a method of manufacturing the power storage device so as to suppress formation of a step due to bending of an end portion of a separator at an end portion of an electrode assembly when inserting the electrode assembly into a case main body.

The present technology provides the following power storage device.
[1] A power storage device comprising: an electrode assembly having a first electrode, a second electrode, and a separator that is interposed between the first electrode and the second electrode and that includes an outermost layer separator covering an outermost side of the electrode assembly; and a case that accommodates the electrode assembly, wherein the case has a case main body that accommodates the electrode assembly and that is provided with an opening, and a sealing plate that seals the opening, a spacer is provided between the sealing plate and the electrode assembly, the spacer has a pair of side walls extending toward the electrode assembly and disposed at a predetermined interval, and the outermost layer separator of the separator has an extension portion extending from an end portion of each of the first electrode and the second electrode toward the spacer, and the extension portion is disposed on an inner side of each of the side walls or is fixed to the side wall.
[2] The power storage device according to [1], wherein the electrode assembly has an electrode tab located on a side of the opening of the case main body and electrically connected to an electrode terminal provided on the sealing plate, and the electrode tab passes through the spacer.
[3] The power storage device according to [2], wherein the case has a prismatic tubular shape, the electrode assembly has a flat shape, and has a first surface substantially parallel to the sealing plate and facing the sealing plate, a pair of second surfaces each extending in a perpendicular direction from the first surface and each located on a long side of the electrode assembly, and a pair of third surfaces extending in a perpendicular direction from the first surface and each located on a short side of the electrode assembly, the electrode tab is provided on a side of the first surface, the side walls of the spacer have a first side wall and a second side wall each extending along the pair of second surfaces, the outermost layer separator has a first outermost layer separator and a second outermost layer separator along the pair of second surfaces, the extension portion of the first outermost layer separator is disposed or fixed on an inner side of the first side wall, and the extension portion of the second outermost layer separator is disposed or fixed on an inner side of the second side wall.
[4] The power storage device according to [3], wherein the first electrode and the second electrode are alternately stacked, the separator includes a portion folded in a meandering manner between the first electrode and the second electrode, and an outer peripheral portion provided to surround an outer side of each of the first electrode and the second electrode, and as the outer peripheral portion, the first outermost layer separator is disposed on an outermost layer side of one side surface, and the second outermost layer separator is disposed on an outermost layer side of the other side surface.
[5] The power storage device according to [4], wherein a whole of the separator located between the first electrode and the second electrode and except for the first outermost layer separator and the second outermost layer separator has the extension portion, and a whole of the extension portion is accommodated in an inner space region between the first side wall and the second side wall.
[6] The power storage device according to [4] or [5], wherein the separator is wound one or more turns at an outermost layer.
[7] The power storage device according to any one of [4] to [6], wherein the separator is fixed to the spacer at positions located at four corners of the spacer.
[8] The power storage device according to any one of [1] to [7], wherein the electrode assembly and the spacer are covered with an insulating sheet, and the insulating sheet is fixed to the spacer.

The present technology provides the following method of manufacturing a power storage device.

A method of manufacturing a power storage device, the power storage device including: an electrode assembly having a first electrode, a second electrode, and a separator that is interposed between the first electrode and the second electrode and that includes an outermost layer separator covering an outermost side of the electrode assembly; and a case that accommodates the electrode assembly, wherein the case has a case main body that accommodates the electrode assembly and that is provided with an opening, and a sealing plate that seals the opening, a spacer is provided between the sealing plate and the electrode assembly, the spacer has a pair of side walls extending toward the electrode assembly and disposed at a predetermined interval, and the outermost layer separator of the separator has an extension portion extending from an end portion of each of the first electrode and the second electrode toward the spacer, and the extension portion is disposed on an inner side of each of the side walls or fixed to the side wall, and in inserting the electrode assembly from the opening into the case main body, the electrode assembly is inserted into the case main body in a state in which the spacer is disposed on a rear end side of the electrode assembly in an insertion direction of the electrode assembly and the extension portion of at least the outermost layer separator of the separator is disposed on the inner side of each of the side walls or is fixed to the side wall.

The method of manufacturing the power storage device according to [9], wherein the electrode assembly has an electrode tab located on a side of the opening of the case main body and electrically connected to an electrode terminal provided on the sealing plate, and the electrode tab passes through the spacer.

The method of manufacturing the power storage device according to [10], wherein the case has a prismatic tubular shape, the electrode assembly has a flat shape, and has a first surface substantially parallel to the sealing plate and facing the sealing plate, a pair of second surfaces each extending in a perpendicular direction from the first surface and each located on a long side of the electrode assembly, and a pair of third surfaces each extending in a perpendicular direction from the first surface and each located on a short side of the electrode assembly, the electrode tab is provided on a side of the first surface, the side walls of the spacer have a first side wall and a second side wall each extending along the pair of second surfaces, the outermost layer separator has a first outermost layer separator and a second outermost layer separator along the pair of second surfaces, and the electrode assembly is inserted into the case main body in a state in which the extension portion of the first outermost layer separator is disposed or fixed on an inner side of the first side wall and the extension portion of the second outermost layer separator is disposed or fixed on an inner side of the second side wall.

The method of manufacturing the power storage device according to [11], wherein the first electrode and the second electrode are alternately stacked, the separator includes a portion folded in a meandering manner between the first electrode and the second electrode, and an outer peripheral portion provided to surround an outer side of each of the first electrode and the second electrode, and as the outer peripheral portion, the first outermost layer separator is disposed on an outermost layer side of one side surface, and the second outermost layer separator is disposed on an outermost layer side of the other side surface.

The method of manufacturing the power storage device according to [12], wherein a whole of the separator located between the first electrode and the second electrode and except for the first outermost layer separator and the second outermost layer separator has the extension portion, and a whole of the extension portion is accommodated in an inner space region between the first side wall and the second side wall.
[14] The method of manufacturing the power storage device according to any one of [12] to [13], wherein the separator is wound one or more turns at an outermost layer.

The method of manufacturing the power storage device according to any one of [11] to [14], wherein the separator is fixed to the spacer at positions located at four corners of the spacer.

The method of manufacturing the power storage device according to any one of [9] to [15], wherein the electrode assembly and the spacer are covered with an insulating sheet, and the insulating sheet is fixed to the spacer.
[17] A power storage device comprising: an electrode assembly having a first electrode, a second electrode, and a separator that is interposed between the first electrode and the second electrode and that includes an outermost layer separator covering an outermost side of the electrode assembly; and a case that accommodates the electrode assembly, wherein the case has a case main body that accommodates the electrode assembly and that is provided with an opening, and a sealing plate that seals the opening, a spacer is provided between the sealing plate and the electrode assembly, the spacer has a pair of side walls extending toward the electrode assembly and disposed at a predetermined interval, the outermost layer separator of the separator has an extension portion extending from an end portion of each of the first electrode and the second electrode toward the spacer, and the extension portion is disposed on an inner side of each of the side walls or is fixed to the side wall, the electrode assembly has an electrode tab located on a side of the opening of the case main body and electrically connected to an electrode terminal provided on the sealing plate, the electrode tab passes through the spacer, the case has a prismatic tubular shape, the electrode assembly has a flat shape, and has a first surface substantially parallel to the sealing plate and facing the sealing plate, a pair of second surfaces each extending in a perpendicular direction from the first surface and each located on a long side of the electrode assembly, and a pair of third surfaces extending in a perpendicular direction from the first surface and each located on a short side of the electrode assembly, the electrode tab is provided on a side of the first surface, the side walls of the spacer have a first side wall and a second side wall each extending along the pair of second surfaces, the outermost layer separator has a first outermost layer separator and a second outermost layer separator along the pair of second surfaces, the extension portion of the first outermost layer separator is disposed or fixed on an inner side of the first side wall, the extension portion of the second outermost layer separator is disposed or fixed on an inner side of the second side wall, the first electrode and the second electrode are alternately stacked, the separator includes a portion folded in a meandering manner between the first electrode and the second electrode, and an outer peripheral portion provided to surround an outer side of each of the first electrode and the second electrode, as the outer peripheral portion, the first outermost layer separator is disposed on an outermost layer side of one side surface, and the second outermost layer separator is disposed on an outermost layer side of the other side surface, a whole of the separator located between the first electrode and the second electrode and except for the first outermost layer separator and the second outermost layer separator has the extension portion, and a whole of the extension portion is accommodated in an inner space region between the first side wall and the second side wall, the separator is wound one or more turns at an outermost layer, and the separator is fixed to the spacer at positions located at four corners of the spacer.

A method of manufacturing a power storage device, the power storage device including: an electrode assembly having a first electrode, a second electrode, and a separator that is interposed between the first electrode and the second electrode and that includes an outermost layer separator covering an outermost side of the electrode assembly; and a case that accommodates the electrode assembly, wherein the case has a case main body that accommodates the electrode assembly and that is provided with an opening, and a sealing plate that seals the opening, a spacer is provided between the sealing plate and the electrode assembly, the spacer has a pair of side walls extending toward the electrode assembly and disposed at a predetermined interval, and the outermost layer separator of the separator has an extension portion extending from an end portion of each of the first electrode and the second electrode toward the spacer, and the extension portion is disposed on an inner side of each of the side walls or fixed to the side wall, in inserting the electrode assembly from the opening into the case main body, the electrode assembly is inserted into the case main body in a state in which the spacer is disposed on a rear end side of the electrode assembly in an insertion direction of the electrode assembly and the extension portion of at least the outermost layer separator of the separator is disposed on the inner side of each of the side walls or is fixed to the side wall, the electrode assembly has an electrode tab located on a side of the opening of the case main body and electrically connected to an electrode terminal provided on the sealing plate, the electrode tab passes through the spacer, the case has a prismatic tubular shape, the electrode assembly has a flat shape, and has a first surface substantially parallel to the sealing plate and facing the sealing plate, a pair of second surfaces each extending in a perpendicular direction from the first surface and each located on a long side of the electrode assembly, and a pair of third surfaces each extending in a perpendicular direction from the first surface and each located on a short side of the electrode assembly, the electrode tab is provided on a side of the first surface, the side walls of the spacer have a first side wall and a second side wall each extending along the pair of second surfaces, the outermost layer separator has a first outermost layer separator and a second outermost layer separator along the pair of second surfaces, the electrode assembly is inserted into the case main body in a state in which the extension portion of the first outermost layer separator is disposed or fixed on an inner side of the first side wall and the extension portion of the second outermost layer separator is disposed or fixed on an inner side of the second side wall, the first electrode and the second electrode are alternately stacked, the separator includes a portion folded in a meandering manner between the first electrode and the second electrode, and an outer peripheral portion provided to surround an outer side of each of the first electrode and the second electrode, as the outer peripheral portion, the first outermost layer separator is disposed on an outermost layer side of one side surface, and the second outermost layer separator is disposed on an outermost layer side of the other side surface, a whole of the separator located between the first electrode and the second electrode and except for the first outermost layer separator and the second outermost layer separator has the extension portion, and a whole of the extension portion is accommodated in an inner space region between the first side wall and the second side wall, the separator is wound one or more turns at an outermost layer, and the separator is fixed to the spacer at positions located at four corners of the spacer.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view showing a configuration of a power storage device according to a first embodiment.

FIG. 2 is a diagram showing a state in which the power storage device shown in FIG. 1 is viewed in a direction of arrow II.

FIG. 3 is a diagram showing a state in which the power storage device shown in FIG. 1 is viewed in a direction of arrow III.

FIG. 4 is a diagram showing a state in which the power storage device shown in FIG. 1 is viewed in a direction of arrow IV.

FIG. 5 is a diagram showing a state in which the power storage device shown in FIG. 1 is viewed in a direction of arrow V.

FIG. 6 is a front cross sectional view of the power storage device shown in FIG. 1.

FIG. 7 is a cross sectional view of a negative electrode.

FIG. 8 is a front view showing the negative electrode.

FIG. 9 is a cross sectional view of a positive electrode.

FIG. 10 is a front view showing the positive electrode.

FIG. 11 is a schematic cross sectional view showing a configuration of an end portion of an electrode assembly.

FIG. 12 is a flowchart showing a method of manufacturing the power storage device.

FIG. 13 is a diagram showing a state in which a current collector is joined to each of the first electrode assembly and the second electrode assembly.

FIG. 14 is a cross sectional view along a line XIV-XIV in FIG. 13.

FIG. 15 is a diagram showing a state in which a sealing plate is assembled to the current collector on the negative electrode side and a spacer is assembled to the electrode assembly.

FIG. 16 is a schematic cross sectional view along a line XVI-XVI in FIG. 15.

FIG. 17 is a cross sectional view showing a problem in a reference technology.

FIG. 18 is a diagram showing a manner of winding the separator around each of the first electrode assembly and the second electrode assembly.

FIG. 19 is a diagram showing a manner of winding the separator around each of the first electrode assembly and the second electrode assembly in another implementation.

FIG. 20 is a diagram showing a state in which an insulating sheet is attached to the electrode assembly.

FIG. 21 is a diagram showing a state in which the electrode assembly in which the insulating sheet is attached is inserted into the case main body.

FIG. 22 is a diagram showing a state in which the insertion of the electrode assembly, in which the insulating sheet is attached, into the case main body is completed.

FIG. 23 is a diagram showing a state in which the sealing plate is assembled to the current collector on the positive electrode side.

FIG. 24 is a diagram showing a state in which the opening of the case main body is sealed.

FIG. 25 is a perspective view showing a configuration of a spacer according to the first embodiment.

FIG. 26 is a perspective view showing a configuration of a spacer according to another implementation.

FIG. 27 is a perspective view showing a configuration of a spacer according to still another implementation.

FIG. 28 is a diagram showing an arrangement relation between a spacer and a separator in another implementation.

FIG. 29 is a diagram showing an arrangement relation between a spacer and a separator in still another implementation.

### DESCRIPTION OF THE PREFERRED EMBODIMENTS

Hereinafter, embodiments of the present technology will be described. It should be noted that the same or corresponding portions are denoted by the same reference characters, and may not be described repeatedly.

In the embodiments described below, when reference is made to number, amount, and the like, the scope of the present technology is not necessarily limited to the number, amount, and the like unless otherwise stated particularly. Further, in the embodiments described below, each component is not necessarily essential to the present technology unless otherwise stated particularly. Further, the present technology is not limited to one that necessarily exhibits all the functions and effects stated in the present embodiment.

In the present specification, the terms “comprise”, “include”, and “have” are open-end terms. That is, when a certain configuration is included, a configuration other than the foregoing configuration may or may not be included.

In the present specification, when geometric terms and terms representing positional/directional relations are used, for example, when terms such as “parallel”, “orthogonal”, “obliquely at 45°”, “coaxial”, and “along” are used, these terms permit manufacturing errors or slight fluctuations. In the present specification, when terms representing relative positional relations such as “upper side” and “lower side” are used, each of these terms is used to indicate a relative positional relation in one state, and the relative positional relation may be reversed or turned at any angle in accordance with an installation direction of each mechanism (for example, the entire mechanism is reversed upside down).

In the present specification, the term “power storage device” may include a lithium ion battery as well as a nickel-metal hydride battery, a sodium-ion battery, and the like. In the present specification, the term “electrode” may collectively represent a positive electrode and a negative electrode.

In the figures, when an electrode assembly included in the power storage device is a stacked type electrode assembly, an X direction is defined as a long-side direction of a stacked surface, whereas when the electrode assembly is a wound type electrode assembly, the X direction is defined as a direction along a winding axis thereof. Further, a Y direction is defined as a short-side direction of the electrode assembly when viewed in the X direction, and a Z direction is defined as a long-side direction of the electrode assembly when viewed in the X direction. In order to facilitate understanding of the invention, the size of each configuration in the figures may be illustrated to be changed from its actual size.

In the present specification, the X direction may be referred to as a “width direction” of each of a power storage device 1, an electrode assembly 200, and a case main body 110, the Z direction may be referred to as a “height direction” of each of power storage device 1, electrode assembly 200, and case main body 110, and the Y direction may be referred to as a “thickness direction” of each of power storage device 1, electrode assembly 200, and case main body 110.

### First Embodiment: Overall Configuration of Power Storage Device

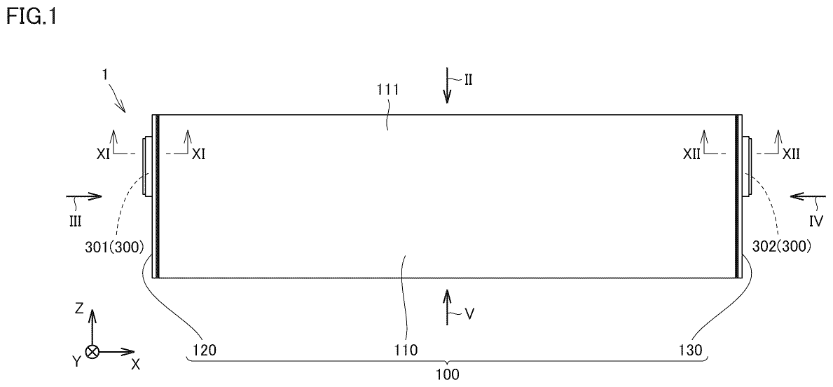

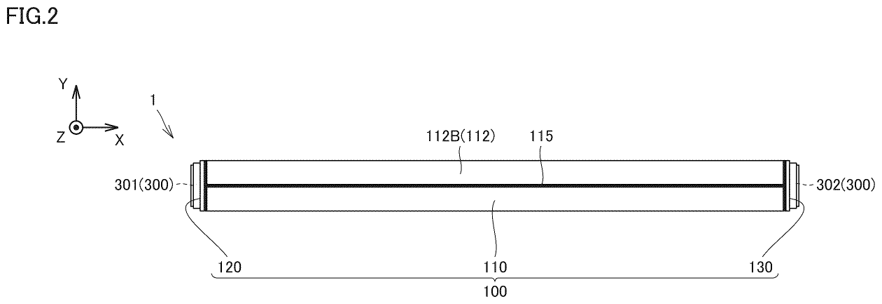

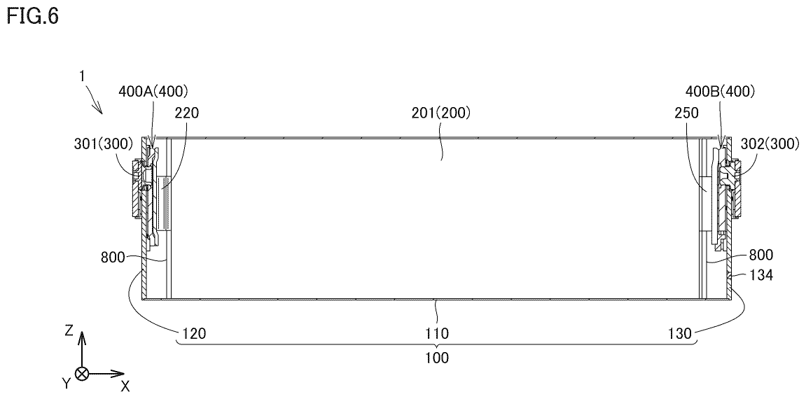

FIG. 1 is a front view of power storage device 1 according to a first embodiment. FIGS. 2 to 5 are diagrams showing states of power storage device 1 shown in FIG. 1 when viewed in directions of arrows II, III, IV, and V respectively. FIG. 6 is a front cross sectional view of power storage device 1 shown in FIG. 1.

Power storage device 1 can be mounted on a battery electric vehicle (BEV), a plug-in hybrid electric vehicle (PHEV), a hybrid electric vehicle (HEV), or the like. It should be noted that the use of power storage device 1 is not limited to the use in a vehicle.

As shown in FIGS. 1 to 6, power storage device 1 includes a case 100, an electrode assembly 200, electrode terminals 300, and current collectors 400. Case 100 includes a case main body 110, a sealing plate 120, and a sealing plate 130.

When forming a battery assembly including power storage device 1, a plurality of power storage devices 1 are stacked in the thickness direction of each of the plurality of power storage devices 1. Power storage devices 1 arranged may be restrained in the arrangement direction (Y direction) by a restraint member to form a battery module, or the battery assembly may be directly supported by a side surface of a case of a battery pack without using the restraint member.

Case main body 110 is constituted of a member having a tubular shape, preferably, a prismatic tubular shape. Thus, power storage device 1 having a prismatic tubular shape is obtained. Case main body 110 is composed of a metal. Specifically, case main body 110 is composed of aluminum, an aluminum alloy, iron, an iron alloy, or the like.

As shown in FIGS. 1 and 2, sealing plate 120 and sealing plate 130 are provided at respective end portions of case main body 110. Case main body 110 can be formed to have a prismatic tubular shape in, for example, the following manner: end sides of a plate-shaped member having been bent are brought into abutment with each other (joining portion 115 illustrated in FIG. 2) and are joined together (for example, laser welding). Each of the corners of the “prismatic tubular shape” may have a shape with a curvature. Further, the power storage device in the present technology 10 is not limited to the prismatic tubular shape.

In the present embodiment, case main body 110 is formed to be longer in the width direction (X direction) of power storage device 1 than in each of the thickness direction (Y direction) and the height direction (Z direction) of power storage device 1. The size (width) of case main body 110 in the X direction is preferably about 30 cm or more. In this way, power storage device 1 can be formed to have a relatively large size (high capacity). The size (height) of case main body 110 in the Z direction is preferably about 20 cm or less, more preferably about 15 cm or less, and further preferably about 10 cm or less. Thus, (low-height) power storage device 1 having a relatively low height can be formed, thus resulting in improved ease of mounting on a vehicle, for example.

Case main body 110 includes a pair of first side surface portions 111 and a pair of second side surface portions 112. The pair of first side surface portions 111 constitute parts of the side surfaces of case 100. The pair of second side surface portions 112 constitute the bottom surface portion and upper surface portion of case 100. The pair of first side surface portions 111 and the pair of second side surface portions 112 are provided to intersect each other. The pair of first side surface portions 111 and the pair of second side surface portions 112 are connected at their respective end portions. Each of the pair of first side surface portions 111 has an area larger than that of each of the pair of second side surface portions 112.

As shown in FIG. 5, a gas-discharge valve 150 is provided in one second side surface portion 112A of the pair of second side surface portions 112. Gas-discharge valve 150 extends in the width direction (X direction) of power storage device 1. Gas-discharge valve 150 extends from the center of case main body 110 in the X direction to such an extent that gas-discharge valve 150 does not reach both ends of case main body 110 in the X direction. The shape of gas-discharge valve 150 can be changed appropriately.

The thickness of the plate-shaped member in gas-discharge valve 150 is thinner than the thickness of the plate-shaped member of case main body 110 other than gas-discharge valve 150. Thus, when the pressure in case 100 becomes equal to or more than a predetermined value, gas-discharge valve 150 is fractured prior to the other portions of case main body 110, thereby discharging the gas in case 100 to the outside.

As shown in FIG. 2, joining portion 115 is formed at the other second side surface portion 112B of the pair of second side surface portions 112. Joining portion 115 extends in the width direction (X direction) of power storage device 1. At joining portion 115, the end sides of the plate-shaped member constituting case main body 110 are joined to each other.

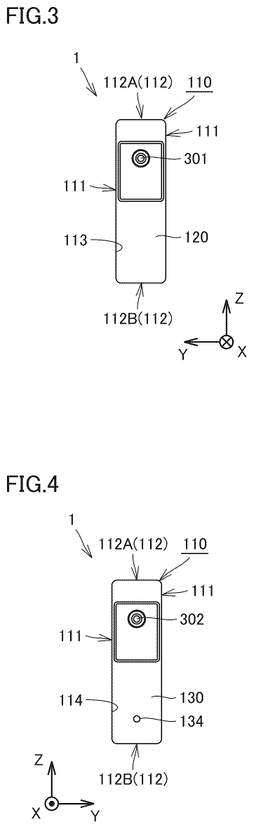

As shown in FIG. 3, an opening 113 (first opening) is provided at an end portion of case main body 110 on the-X side in the X direction. Opening 113 is sealed by sealing plate 120 (first sealing plate). Joining portion 115 is formed at opening 113 so as to seal opening 113. Each of opening 113 and sealing plate 120 has a substantially rectangular shape in which the Y direction corresponds to its short-side direction and the Z direction corresponds to its long-side direction. The substantially rectangular shape includes a rectangular shape or a generally rectangular shape such as a rectangular shape having corners each with a curvature.

A negative electrode terminal 301 (first electrode terminal) is provided on sealing plate 120. The position of negative electrode terminal 301 can be appropriately changed. Negative electrode terminal 301 is exposed to the outside of sealing plate 120.

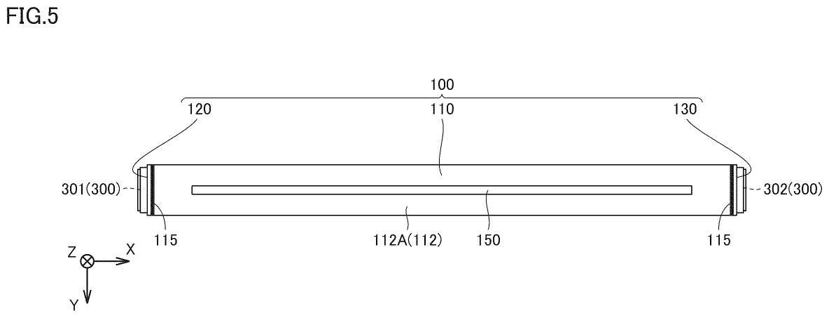

As shown in FIG. 4, an opening 114 (second opening) is provided at an end portion of case main body 110 on the +X side in the X direction. Opening 114 is located at an end portion opposite to opening 113, and openings 113, 114 face each other. Opening 114 is sealed by sealing plate 130 (second sealing plate). Joining portion 115 is formed at opening 114 so as to seal opening 114. Each of opening 114 and sealing plate 130 has a substantially rectangular shape in which the Y direction corresponds to its short-side direction and the Z direction corresponds to its long-side direction.

Sealing plate 130 is provided with a positive electrode terminal 302 (second electrode terminal) and an injection hole 134. The positions of positive electrode terminal 302 and injection hole 134 can be appropriately changed.

Each of sealing plate 120 and sealing plate 130 is composed of a metal. Specifically, each of sealing plate 120 and sealing plate 130 is composed of aluminum, an aluminum alloy, iron, an iron alloy, or the like.

Negative electrode terminal 301 is electrically connected to a negative electrode of electrode assembly 200. Negative electrode terminal 301 is attached to sealing plate 120, i.e., case 100. Negative electrode terminal 301 is composed of a conductive material (more specifically, a metal), and can be composed of copper, a copper alloy, or the like, for example. A portion or layer composed of aluminum or an aluminum alloy may be provided at a portion of an outer surface of negative electrode terminal 301.

Positive electrode terminal 302 is electrically connected to a positive electrode of electrode assembly 200. Positive electrode terminal 302 is attached to sealing plate 130, i.e., case 100. Positive electrode terminal 302 is composed of a conductive material (more specifically, a metal), and can be composed of aluminum, an aluminum alloy, or the like, for example. Positive electrode terminal 302 is exposed to the outside of sealing plate 130.

Injection hole 134 is sealed by a sealing member (not shown). As the sealing member, for example, a blind rivet or another metal member can be used.

Electrode assembly 200 is an electrode assembly having a flat shape and having a below-described positive electrode and a below-described negative electrode stacked on each other. Specifically, electrode assembly 200 is, for example, a stacked type electrode assembly in which a plurality of positive electrodes and a plurality of negative electrodes are alternately stacked with a separator (described below) being interposed therebetween. In the present specification, the “electrode assembly” is not limited to the stacked type electrode assembly, and may be a wound type electrode assembly in which a strip-shaped positive electrode and a strip-shaped negative electrode are wound together with a strip-shaped separator being interposed therebetween. The separator can be constituted of, for example, a microporous membrane composed of polyolefin. When electrode assembly 200 is the stacked type electrode assembly including the plurality of positive electrodes and the plurality of negative electrodes, positive electrode tabs provided on the positive electrodes can be stacked to form a positive electrode tab group, and negative electrode tabs provided on the negative electrodes can be stacked to form a negative electrode tab group.

As shown in FIG. 6, case 100 accommodates electrode assembly 200. FIG. 6 illustrates a first electrode assembly 201 described below. First electrode assembly 201 is accommodated in case 100 such that the long-side direction thereof is parallel to the X direction.

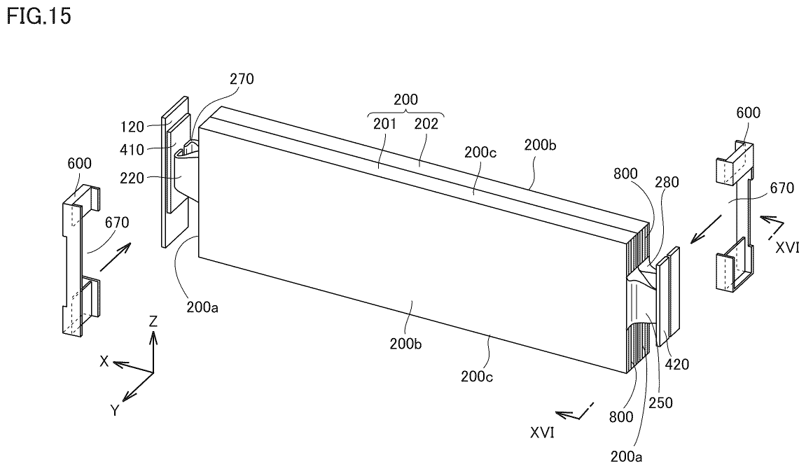

Specifically, one or a plurality of the stacked type electrode assemblies and an electrolyte solution (electrolyte) (not shown) are accommodated inside an insulating sheet 700 (see FIG. 15) disposed in case 100. Instead of the electrolyte solution, a solid electrolyte may be used.

First electrode assembly 201 includes a main body portion having a substantially rectangular shape, a negative electrode tab group 220, and a positive electrode tab group 250. Negative electrode tab group 220 is located at an end portion of first electrode assembly 201 on the-X side with respect to the main body portion thereof in the X direction. Positive electrode tab group 250 is located at an end portion of first electrode assembly 201 on the +X side with respect to the main body portion thereof in the X direction. Although details will be described later, the end portions of a separator 800 are exposed at the both end portions (the negative electrode tab group 220 side and the positive electrode tab group 250 side) of first electrode assembly 201.

Each of negative electrode tab group 220 and positive electrode tab group 250 is formed to protrude from a substantially central portion of electrode assembly 200 toward sealing plate 120 or sealing plate 130.

Current collectors 400 include a negative electrode current collector 400A and a positive electrode current collector 400B. Electrode assembly 200 is electrically connected to negative electrode terminal 301 and positive electrode terminal 302 through current collectors 400.

Negative electrode current collector 400A is electrically connected to negative electrode tab group 220 and negative electrode terminal 301. Negative electrode current collector 400A can be composed of a conductive material (more specifically, a metal such as copper or a copper alloy).

Positive electrode current collector 400B is electrically connected to positive electrode tab group 250 and positive electrode terminal 302. Positive electrode current collector 400B can be composed of a conductive material (more specifically, a metal such as aluminum or an aluminum alloy).

### Configuration of Electrode Assembly 200

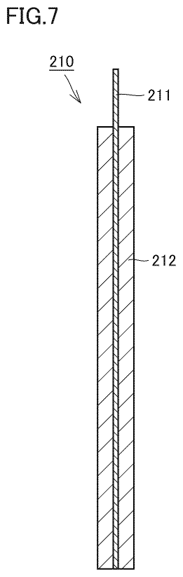

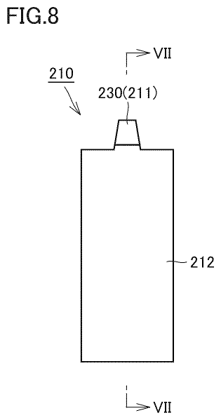

FIG. 7 is a cross sectional view of negative electrode 210 (first electrode) (cross sectional view along VII-VII in FIG. 8), and FIG. 8 is a front view showing negative electrode 210.

As shown in FIG. 8, negative electrode 210 includes a negative electrode core body 211 and a negative electrode active material layer 212. Negative electrode core body 211 is a copper foil or a copper alloy foil. Negative electrode active material layer 212 is formed by applying a negative electrode active material layer slurry using a die coater.

A negative electrode tab 230 constituted of a negative electrode core body 211 is provided at one end portion, in the width direction, of negative electrode 210. When negative electrodes 210 are stacked, a plurality of negative electrode tabs 230 are stacked to form negative electrode tab group 220. The length of each of the plurality of negative electrode tabs 230 in the plurality of negative electrodes 210 in the protruding direction is appropriately adjusted in consideration of the state in which negative electrode tab group 220 is connected to negative electrode current collector 400A. The shape of negative electrode tab 230 is not limited to the one illustrated in FIG. 8.

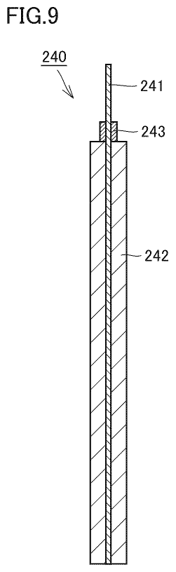

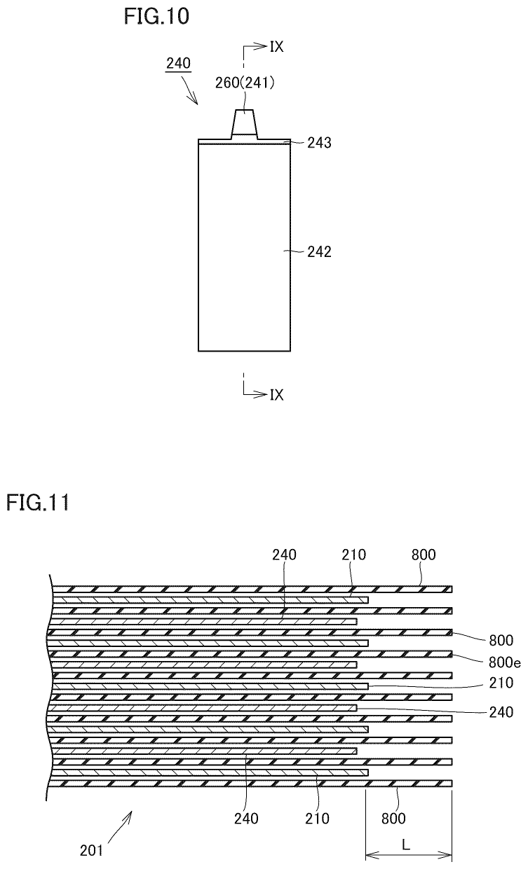

FIG. 9 is a cross sectional view of positive electrode 240 (second electrode) (cross sectional view along IX-IX in FIG. 10), and FIG. 10 is a front view showing positive electrode 240.

As shown in FIG. 10, positive electrode 240 has a polarity different from a polarity of negative electrode 210. Positive electrode 240 includes a positive electrode core body 241, a positive electrode active material layer 242, and a positive electrode protective layer 243. Positive electrode core body 241 is an aluminum foil or an aluminum alloy foil. Positive electrode active material layer 242 is formed on positive electrode core body 241 by applying a positive electrode active material layer slurry using a die coater.

A positive electrode tab 260 constituted of positive electrode core body 241 is provided at one end portion, in the width direction, of positive electrode 240. When positive electrodes 240 are stacked, a plurality of positive electrode tabs 260 are stacked to form positive electrode tab group 250. The length of each of positive electrode tabs 260 in the plurality of positive electrodes 240 in the protruding direction is appropriately adjusted in consideration of the state in which positive electrode tab group 250 is connected to positive electrode current collector 400B. The shape of positive electrode tab 260 is not limited to the one illustrated in FIG. 10.

Positive electrode protective layer 243 is provided at the root of positive electrode tab 260. It should be noted that positive electrode protective layer 243 may not necessarily be provided.

In a typical example, the thickness of (one) negative electrode tab 230 is smaller than the thickness of (one) positive electrode tab 260. In this case, the thickness of negative electrode tab group 220 is smaller than the thickness of positive electrode tab group 250.

As shown in FIG. 11, in first electrode assembly 201, negative electrodes 210 and positive electrodes 240 are alternately stacked to form first electrode assembly 201. Separator 800 is disposed between each negative electrode 210 and each positive electrode 240. As separator 800 disposed between negative electrode 210 and positive electrode 240, separator 800 having a strip shape may be folded in a meandering manner between negative electrodes 210 and positive electrodes 240. Separator 800 may be disposed to extend back and forth between negative electrodes 210 and positive electrodes 240. The arrangement of separator 800 disposed between negative electrodes 210 and positive electrodes 240 will be described later.

Separator 800 may include: a portion folded in a meandering manner between negative electrodes 210 and positive electrodes 240; and an outer peripheral portion provided to surround an outer side of each of negative electrodes 210 and positive electrodes 240. The portion provided between negative electrodes 210 and positive electrodes 240 and the outer peripheral portion surrounding the outer side of each of negative electrodes 210 and positive electrodes 240 may be separately provided. The portion provided between negative electrodes 210 and positive electrodes 240 is not limited to the portion in which separator 800 having the strip shape is folded in the meandering manner and individual separators each having a rectangular shape may be individually provided one by one.

The end portion of separator 800 on the negative electrode tab group 220 side and the end portion of separator 800 on the positive electrode tab group 250 side are arranged such that the end portions of separator 800 have extension portions 800e protruding with respect to the end portions of negative electrode 210 and positive electrode 240. As shown in FIG. 11, for example, protruding length L of each end portion of separator 800 (length of extension portion 800e) is appropriately adjusted in consideration of each of a distance from the end portion of negative electrode 210 to opening 113 on the negative electrode side and a distance from the end portion of positive electrode 240 to opening 114 on the positive electrode side.

### Process of Manufacturing Power Storage Device 1

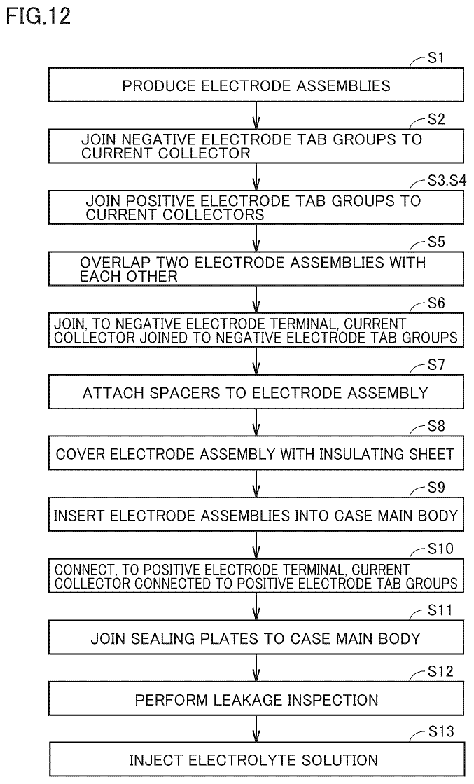

Hereinafter, a method of manufacturing the power storage device according to the present embodiment will be described. FIG. 12 is a flowchart showing the method of manufacturing power storage device 1.

As shown in FIG. 12, the method of manufacturing power storage device 1 includes: a step (S1) of producing first electrode assembly 201 and a second electrode assembly 202; a step (S2) of joining negative electrode tab group 220 and negative electrode tab group 270 to a current collector 410; a step (S3) of joining positive electrode tab group 250 to a current collector 420; a step (S4) of joining positive electrode tab group 280 to current collector 420; a step (S5) of overlapping first electrode assembly 201 and second electrode assembly 202 with each other; a step (S6) of electrically connecting, to negative electrode terminal 301, current collector 410 joined to negative electrode tab group 220 and negative electrode tab group 270; a step (S7) of attaching spacers 600 to electrode assembly 200; a step (S8) of covering electrode assembly 200 with an insulating sheet; a step (S9) of inserting first electrode assembly 201 and second electrode assembly 202 into case main body 110; a step (S10) of electrically connecting, to positive electrode terminal 302, current collector 420 joined to positive electrode tab groups 250, 280; a step (S11) of joining sealing plates 120, 130 to case main body 110 so as to seal openings 113, 114; a step (S12) of performing a leakage inspection; and a step (S13) of injecting the electrolyte solution.

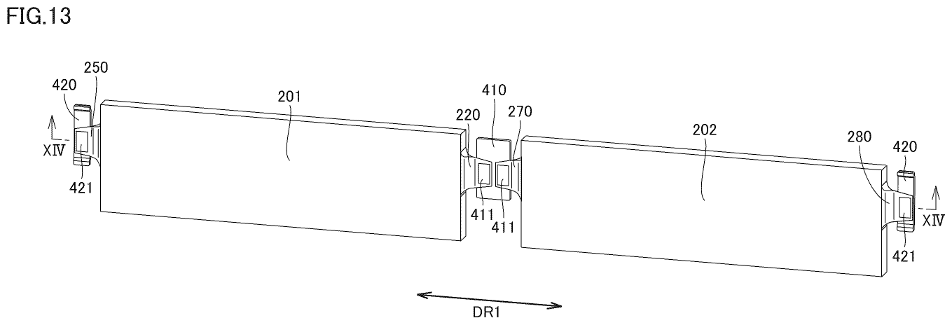

Each of FIGS. 13 to 24 is a diagram showing a step in the method of manufacturing power storage device 1. In the step (S1) of producing first electrode assembly 201 and second electrode assembly 202, parts of the tips of negative electrode tab group 220, positive electrode tab group 250, negative electrode tab group 270, and positive electrode tab group 280 are preferably cut such that they have the same tip length when bundled.

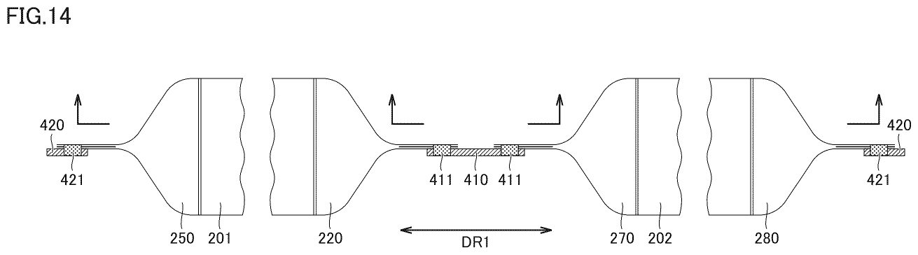

Referring to FIGS. 13 and 14, after producing first electrode assembly 201 and second electrode assembly 202, negative electrode tab groups 220, 270 are joined to current collector 410 (S2), positive electrode tab group 250 is joined to current collector 420 (S3), and positive electrode tab group 280 is joined to current collector 420 (S4).

Each of negative electrode tab groups 220, 270 is joined to current collector 410 at a joining portion 411. Positive electrode tab group 250 is joined to current collector 420 at a joining portion 421. Positive electrode tab group 280 is joined to current collector 420 at a joining portion 421.

Current collector 420, first electrode assembly 201, current collector 410, second electrode assembly 202, and current collector 420 are arranged side by side in this order in a direction of arrow DR1.

In the example of FIG. 13, in the height direction of each of first electrode assembly 201 and second electrode assembly 202, each of current collector 410 and current collector 420 is disposed on one side with respect to the center of a corresponding one of first electrode assembly 201 and second electrode assembly 202. In the height direction of each of first electrode assembly 201 and second electrode assembly 202, each of negative electrode tab group 220, positive electrode tab group 250, negative electrode tab group 270, and positive electrode tab group 280 is disposed on one side with respect to the center of a corresponding one of first electrode assembly 201 and second electrode assembly 202.

The scope of the present technology is not limited thereto, and in the height direction of each of first electrode assembly 201 and second electrode assembly 202, each of current collector 410 and current collector 420 may be disposed at the center of a corresponding one of first electrode assembly 201 and second electrode assembly 202. In the height direction of each of first electrode assembly 201 and second electrode assembly 202, each of negative electrode tab group 220, positive electrode tab group 250, negative electrode tab group 270, and positive electrode tab group 280 may be disposed at the center of a corresponding one of first electrode assembly 201 and second electrode assembly 202.

As shown in FIG. 15, negative electrode tab group 220 and negative electrode tab group 270 are bent in the thickness direction of each of first electrode assembly 201 and second electrode assembly 202 (direction orthogonal to the DR1 direction in FIGS. 13 and 14) so as to overlap first electrode assembly 201 and second electrode assembly 202 with each other (S5). Here, negative electrode tab group 220 and negative electrode tab group 270 are bent such that their tip portions face each other. The direction in which negative electrode tab group 220 and negative electrode tab group 270 are bent is not limited to the direction in which they are bent such that the tip portions thereof face each other.

When “overlapping” first electrode assembly 201 and second electrode assembly 202 with each other, first electrode assembly 201 and second electrode assembly 202 may be overlapped with each other directly, or another member may be disposed between first electrode assembly 201 and second electrode assembly 202. First electrode assembly 201 and second electrode assembly 202 may or may not be fixed by a tape or the like.

Electrode assembly 200 in which first electrode assembly 201 and second electrode assembly 202 are overlapped with each other has a flat rectangular shape, and has a first surface 200a substantially parallel to sealing plate 120 and facing sealing plate 120, a pair of second surfaces 200b each extending in a perpendicular direction from first surface 200a and each located on the long side of electrode assembly 200, and a pair of third surfaces 200c extending in a perpendicular direction from first surface 200a and each located on the short side of electrode assembly 200.

As shown in FIG. 15, current collector 410 joined to negative electrode tab group 220 and negative electrode tab group 270 is assembled to sealing plate 120 (S6). Negative electrode terminal 301 is attached to sealing plate 120 in advance. Thus, current collector 410 is electrically connected to negative electrode terminal 301 (S5).

Next, spacers 600 are attached to the negative electrode side and the positive electrode side of electrode assembly 200 (S7). A detailed structure of each of spacers 600 will be described later. On the negative electrode side, spacer 600 is attached to electrode assembly 200 such that negative electrode tab group 220 and negative electrode tab group 270 are accommodated in an opening 670 provided in spacer 600. On the positive electrode side, spacer 600 is attached to electrode assembly 200 such that positive electrode tab group 250 and positive electrode tab group 280 are accommodated in an opening 670 provided in spacer 600.

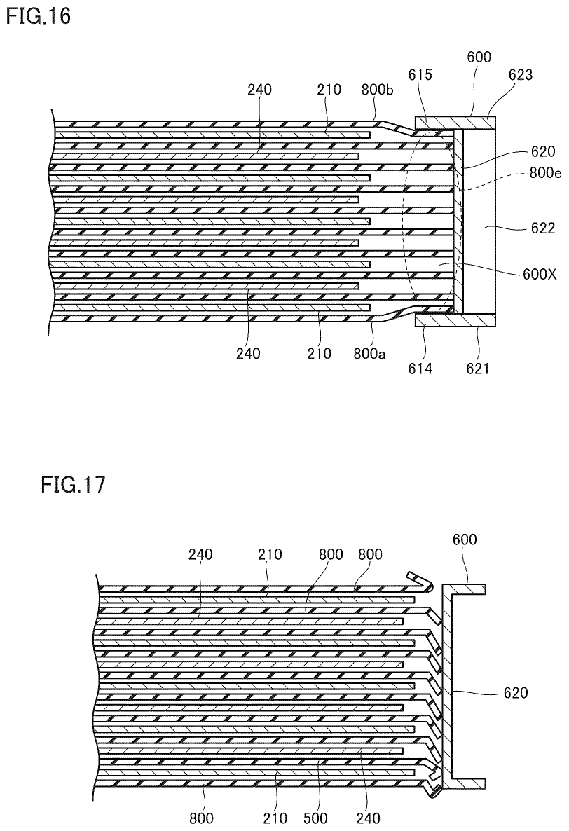

Referring to FIG. 16, when attaching spacers 600 onto the negative electrode side and the positive electrode side of electrode assembly 200, at least extension portion 800e of a first outermost layer separator 800a located outermost on one side of electrode assembly 200 is disposed to be located on the inner side of a third side wall 614 provided in each spacer 600, and extension portion 800e of a second outermost layer separator 800b located outermost on the other side thereof is disposed to be located on the inner side of a fourth side wall 615.

Third side wall 614 and fourth side wall 615 are side walls provided so as to extend from a first base 610 and a second base 620 of spacer 600 toward the electrode assembly 200 side. The inner side of third side wall 614 and the inner side of fourth side wall 615 mean a space region 600X in which third side wall 614 and fourth side wall 615 face each other.

Thus, first outermost layer separator 800a and second outermost layer separator 800b located outermost in electrode assembly 200 are disposed to be located in inner space region 600X between third side wall 614 and fourth side wall 615 provided in spacer 600, with the result that separator 800 located internal to first outermost layer separator 800a located on the outer side is accommodated in inner space region 600X between third side wall 614 and fourth side wall 615. As a result, it is possible to suppress extension portion 800e (end portion) of separator 800 from being unintentionally bent in a subsequent step, i.e., when inserting electrode assembly 200 into case main body 110.

In the present embodiment, the whole of separator 800 has extension portions 800e, and the whole of extension portions 800e is accommodated in inner space region 600X between third side wall 614 and fourth side wall 615, with the result that the whole of extension portions 800e can be suppressed from being unintentionally bent.

FIG. 16 shows a relation between separator 800 and spacer 600 on the positive electrode side, but the same applies to the negative electrode side. For example, when the positive electrode side is on the front side in the insertion direction and the negative electrode side is on the rear side in the insertion direction at the time of inserting electrode assembly 200 into case main body 110, the negative electrode side (rear side) is pushed into case main body 110. Therefore, it is preferable to have, at least on the negative electrode side, a structure representing the above-described relation between separator 800 and spacer 600.

Referring to FIG. 17, the following describes a case of a reference technology in which third side wall 614 and fourth side wall 615 are not provided in spacer 600. The end portions of separator 800 are in direct contact with first base 610 and second base 620 of spacer 600. As a result, the end portions of separator 800 are bent to cause bent layers of the separator, thereby causing formation of a step such as a crease. When the step reaches the end portions of the electrode assembly, the step faces an active material layer provided on each of the surfaces of the positive electrode plate and the negative electrode plate, with the result that precipitation of Li may occur on the surface of each of the positive electrode plate and the negative electrode plate due to the step as the power storage device are charged and discharged.

However, in the configuration of the present disclosure, as described above, it is possible to suppress the end portions of separator 800 from being unintentionally bent, with the result that the precipitation of Li can be suppressed from occurring on each of the surfaces of the positive electrode plate and the negative electrode plate.

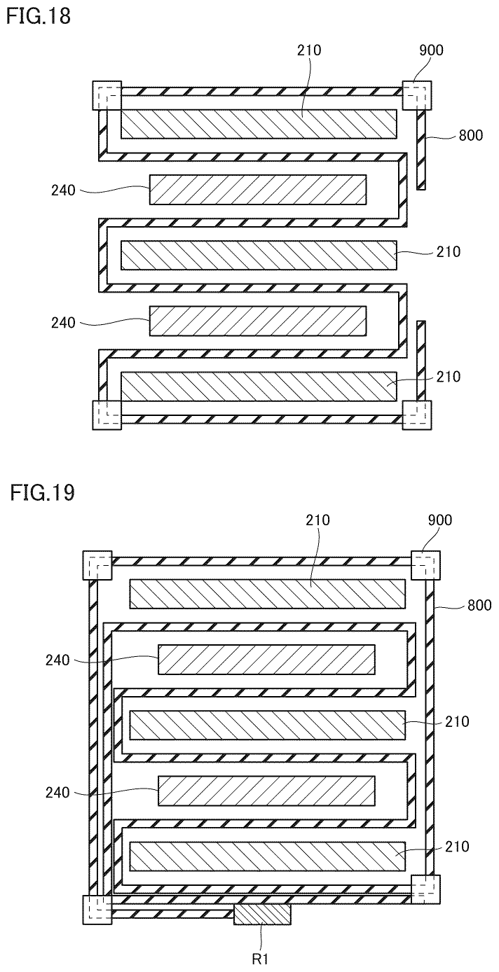

The arrangement of separator 800 disposed between negative electrode 210 and positive electrode 240 in first electrode assembly 201 will be described with reference to FIG. 18. Since the same applies to second electrode assembly 202, explanation therefor will be omitted here. Separator 800 is, for example, in the form of a single sheet, and is disposed to extend back and forth between negative electrodes 210 and positive electrodes 240. Separator 800 located outermost on one side is first outermost layer separator 800a, and separator 800 located outermost on the other side is second outermost layer separator 800b. Separator 800 may be fixed to the four corners of spacer 600 using fixing members 900 such as tapes or welding.

Referring to FIG. 19, as another implementation of the arrangement of separator 800 shown in FIG. 18, separator 800 is disposed by winding separator 800 one more turn at the outermost layer. Separator 800 may be wound one more turn or more than one turn.

In the case of folding separator 800 in the meandering manner in which separator 800 extends back and forth as shown in each of FIGS. 18 and 19, when extension portion 800e of separator 800 located on the second surface 200b side of electrode assembly 200 and extension portion 800e of separator 800 located on the third surface 200c side are compared, extension portion 800e of separator 800 located on the second surface 200b side has a mountain-fold shape. As a result, bending is less likely to occur in extension portion 800e having the mountain-fold shape. Therefore, extension portion 800e may be provided only in separator 800 located on the second surface 200b side of electrode assembly 200. The same applies to the electrode assembly in which negative electrode 210 and positive electrode 240 are wound.

It should be noted that in the case of an individual-sheet type in which separator 800 is not a single sheet and separators 800 are individually disposed between negative electrodes 210 and positive electrodes 240, no mountain-fold shape is formed, so that it is favorable to provide the extension portions of separator 800 on the first surface 200a side as well as on the second surface 200b side.

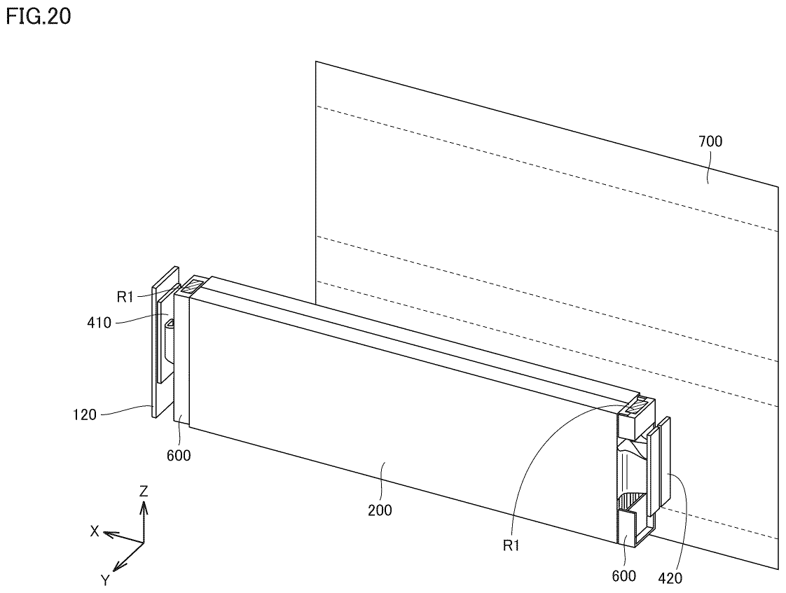

Next, as shown in FIG. 20, electrode assembly 200 is covered with insulating sheet 700 (S8). When electrode assembly 200 is covered with insulating sheet 700, each of spacers 600 may also be covered with insulating sheet 700. Insulating sheet 700 may be fixed at a fixing region R1 of spacer 600 with portions of insulating sheet 700 being overlapped with each other on the upper surface of spacer 600. The overlapping length of insulating sheet 700 on the upper surface of spacer 600 may be about 0.1 mm to 4.2 mm.

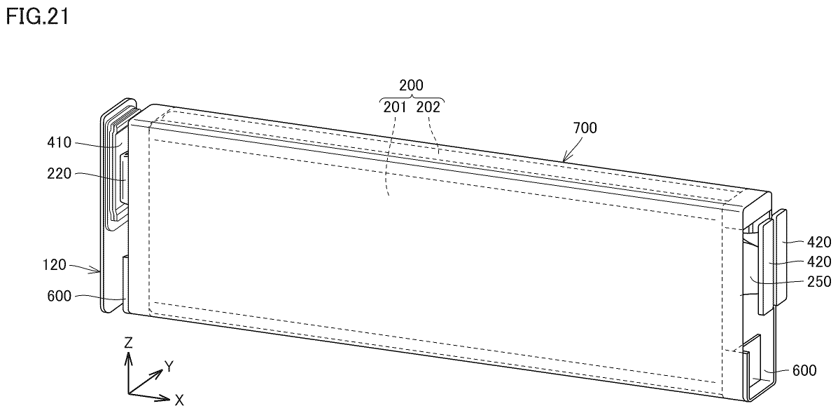

As shown in FIG. 21, in a state in which electrode assembly 200 and spacers 600 located on both sides thereof are covered with insulating sheet 700 (hereinafter, this state is simply referred to as electrode assembly 200), electrode assembly 200 is inserted into case main body 110 with the current collector 420 side, i.e., the positive electrode side being the front side (inserted first) and the current collector 410 side, i.e., the negative electrode side being the rear side (S9).

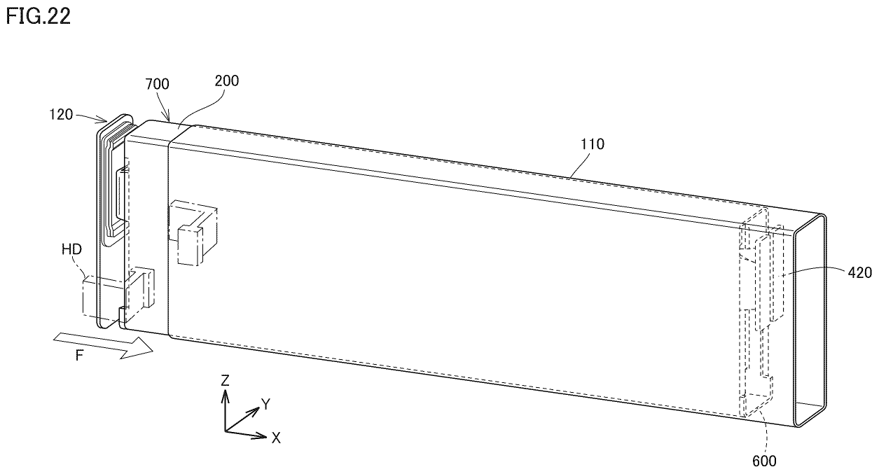

As shown in FIG. 22, when inserting electrode assembly 200 into case main body 110 (in a direction of arrow F in the figure), a region of electrode assembly 200 close to the negative electrode side is held by a robot hand HD or the like, and electrode assembly 200 is inserted with the positive electrode side being inserted first while pushing it from the negative electrode side. By using robot hand HD or the like, about 80% to 90% of electrode assembly 200 in the width direction of electrode assembly 200 is inserted into case main body 110. Thereafter, electrode assembly 200 is inserted in a state in which the rear side (negative electrode side) thereof is pushed.

On this occasion, as described above, the end portions of separator 800 are accommodated in space region 600X between third side wall 614 and fourth side wall 615 provided in spacer 600. As a result, even when electrode assembly 200 is inserted into case main body 110 while pushing the rear side (negative electrode side) thereof, it is possible to suppress the end portions of separator 800 from being unintentionally bent. It should be noted that electrode assembly 200 may be pulled from the positive electrode side.

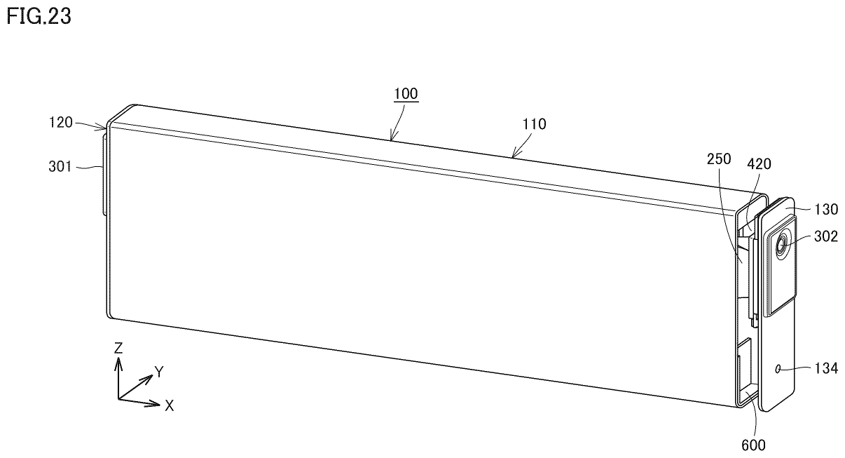

As shown in FIG. 23, after electrode assembly 200 is inserted into case main body 110, current collector 420 joined to positive electrode tab group 250 and positive electrode tab group 280 is assembled to sealing plate 130. Positive electrode terminal 302 is attached to sealing plate 130 in advance. As a result, current collector 430 is electrically connected to positive electrode terminal 302 (S10).

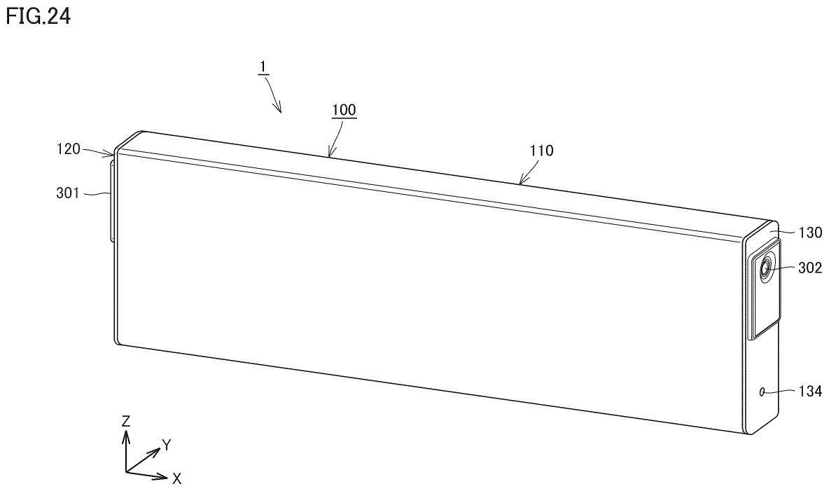

As shown in FIG. 24, sealing plate 120 and sealing plate 130 are joined to case main body 110 (S11). Sealing plate 120 seals opening 113 of case main body 110, and sealing plate 130 seals opening 114 of case main body 110. In this way, electrode assembly 200 is accommodated in case main body 100.

After the above-described steps, an inspection such as a leakage inspection is performed (S12). After the leakage inspection, power storage device 1 is dried to remove moisture in case 100. The electrolyte solution is injected into case 100 through injection hole 134 (S13). When injecting the electrolyte solution, case 100 is inclined with sealing plate 130 facing upward and sealing plate 120 facing downward, thereby injecting the electrolyte solution into case 100 via injection hole 134 of sealing plate 130. Thereafter, charging is performed to result in release of gas. For performing the charging to result in release of gas, injection hole 134 may be temporarily sealed. Thereafter, injection hole 134 is sealed, thereby completing power storage device 1.

The order of the step of inserting electrode assembly 200 and the steps of connecting the current collectors is not limited to the above-described example. For example, the order of the steps (S2 to S5) of joining current collector 410 and current collector 420 can be appropriately changed.

In the present embodiment, it has been illustratively described that current collector 420 is electrically connected to positive electrode terminal 302 (S10) in a state in which electrode assembly 200 is completely disposed in case main body 110 after the step (S9) of inserting electrode assembly 200 into case main body 110 is completed, but electrode assembly 200 and positive electrode terminal 302 may be electrically connected (S10) before the step (S9) of inserting electrode assembly 200 into case main body 110 is completely completed (during the insertion step).

In the present embodiment, it has been described that electrode assembly 200 is inserted into case main body 110 with the current collector 420 side, i.e., the positive electrode side being the front side (inserted first) and the current collector 410 side, i.e., the negative electrode side being the rear side (S9), but electrode assembly 200 may be inserted into case main body 110 with the current collector 410 side, i.e., the negative electrode side being the front side (inserted first) and the current collector 420 side, i.e., the positive electrode side being the rear side.

### Spacer 600

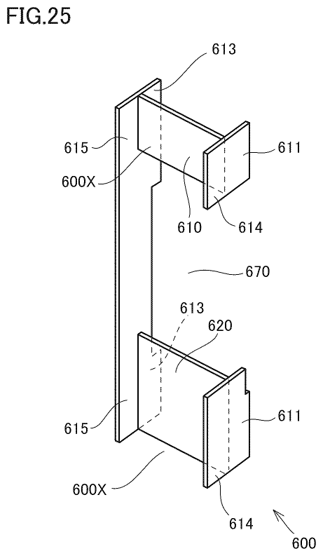

A detailed structure of spacer 600 will be described with reference to FIG. 25. Spacer 600 is preferably a resin-molded product. Spacer 600 has a rectangular shape as a whole. Spacer 600 has first base 610 and second base 620 each having a rectangular shape. First base 610 and second base 620 are disposed at a predetermined interval.

A pair of first side wall 611 and second side wall 613 each extending in a perpendicular direction from first base 610 are provided on one surface side of first base 610. A third side wall 614 extending in a direction opposite to first side wall 611 and a fourth side wall 615 extending in a direction opposite to second side wall 613 are provided on the other surface side of first base 610.

A second side wall 613 and a fourth side wall 615 are provided to be continuous to second base 620. A first side wall 611 is provided on one surface side of second base 620 at a position facing second side wall 613. A third side wall 614 is provided on the other surface side of second base 620 at a position facing fourth side wall 615.

Since first side walls 611 and third side walls 614 are discontinuously provided between first base 610 and second base 620, an opening 670 is formed in spacer 600. Opening 670 serves as a region through which the negative electrode tab group and the positive electrode tab group pass when attaching spacer 600 to electrode assembly 200.

When spacer 600 is attached to electrode assembly 200, the side on which first side walls 611 and second side walls 613 are provided is disposed to face the sealing plate, and the side on which third side walls 614 and fourth side walls 615 are provided is disposed to face first surface 200a of electrode assembly 200. Therefore, extension portions 800e of separator 800 are accommodated in inner space region 600X between third side walls 614 and fourth side walls 615.

### Spacer 600A

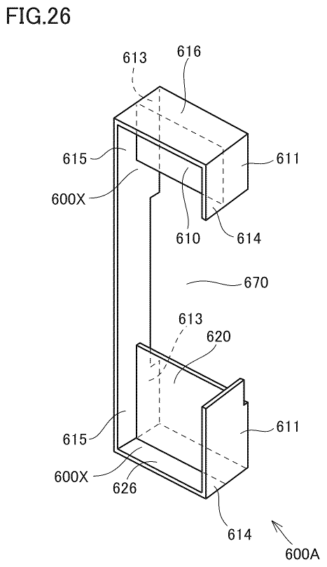

A structure of a spacer 600A of another implementation will be described with reference to FIG. 26. The structure is basically the same as the structure of spacer 600 described above. In spacer 600A, a first coupling plate 616 that couples first side wall 611 and third side wall 614 to second side wall 613 and fourth side wall 615 may be provided on the upper end side of first base 610 (the side opposite to second base 620). Similarly, a second coupling plate 626 that couples first side wall 611 and third side wall 614 to second side wall 613 and fourth side wall 615 may be provided on the lower end side of second base 620 (the side opposite to first base 610).

By providing first coupling plate 616 and second coupling plate 626 in this way, the rigidity of spacer 600A can be increased as compared with spacer 600.

### Spacer 600B

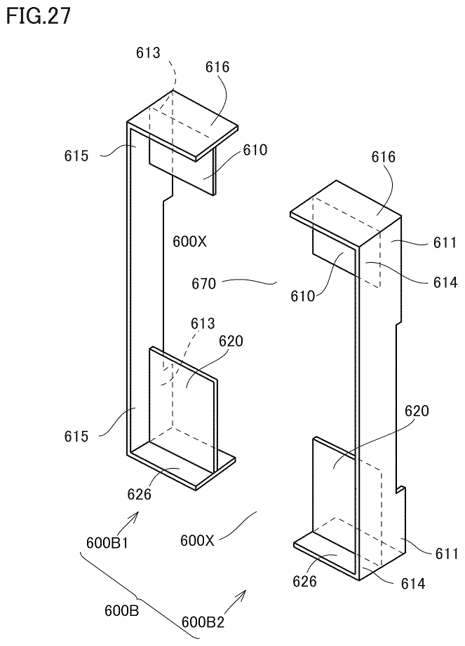

A structure of a spacer 600B according to still another implementation will be described with reference to FIG. 27. The structure is basically the same as the structure of spacer 600A described above. Spacer 600B employs a two-divided structure, has a first divided spacer 600B1 and a second divided spacer 600B2, and first divided spacer 600B1 and second divided spacer 600B2 have symmetrical shapes.

When attaching spacer 600B to electrode assembly 200, spacer 600B is attached thereto such that the negative electrode tab group and the positive electrode tab group can be sandwiched from the second surface 200b side of electrode assembly 200.

### Arrangement of Spacer 600 and Separator 800 in Another Implementation

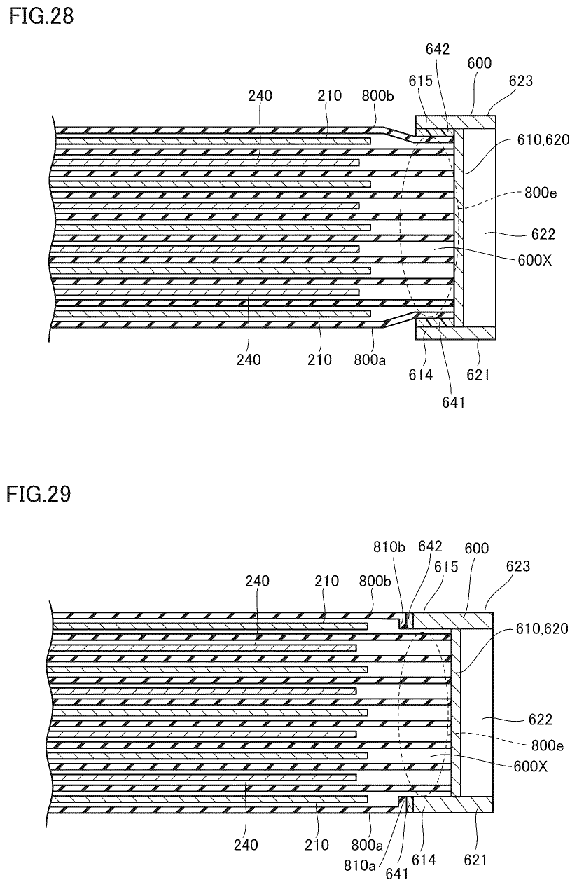

An arrangement relation between spacer 600 and separator 800 in each of other implementations will be described with reference to FIGS. 28 and 29. In the arrangement relation between spacer 600 and separator 800 as shown in FIG. 16, first outermost layer separator 800a and second outermost layer separator 800b located on the outermost sides of electrode assembly 200 are disposed to be located in space region 600X internal to first side walls 611 and second side walls 613 provided in spacer 600.

In the implementation shown in FIG. 28, there is employed such a configuration that first outermost layer separator 800a is fixed to an inner side of third side wall 614 using a fixing member 641 such as an adhesive tape. Similarly, there is employed such a configuration that second outermost layer separator 800b is fixed to an inner side of fourth side wall 615 using a fixing member 642 such as an adhesive tape.

In the implementation shown in FIG. 29, tip portion 810a of first outermost layer separator 800a is fixed to an end surface on the electrode assembly 200 side using a fixing member 641, rather than the inner side of third side wall 614. Similarly, tip portion 810b of second outermost layer separator 800b is fixed to an end surface on the electrode assembly 200 side using a fixing member 642, rather than the inner side of fourth side wall 615.

By employing the configuration in which first outermost layer separator 800a and second outermost layer separator 800b are fixed to spacer 600 in advance in this way, electrode assembly 200 can be inserted into case main body 110 with the positional relation between electrode assembly 200 and spacer 600 being stabilized in the process of manufacturing electrode assembly 200.

Although the embodiments of the present invention have been described and illustrated in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A power storage device comprising: an electrode assembly having a first electrode, a second electrode, and a separator that is interposed between the first electrode and the second electrode and that includes an outermost layer separator covering an outermost side of the electrode assembly; and a case that accommodates the electrode assembly, wherein
the case has
a case main body that accommodates the electrode assembly and that is provided with an opening, and
a sealing plate that seals the opening,
a spacer is provided between the sealing plate and the electrode assembly,
the spacer has a pair of side walls extending toward the electrode assembly and disposed at a predetermined interval, and
the outermost layer separator of the separator has an extension portion extending from an end portion of each of the first electrode and the second electrode toward the spacer, and the extension portion is disposed on an inner side of each of the side walls or is fixed to the side wall.

2. The power storage device according to claim 1, wherein
the electrode assembly has an electrode tab located on a side of the opening of the case main body and electrically connected to an electrode terminal provided on the sealing plate, and
the electrode tab passes through the spacer.

3. The power storage device according to claim 2, wherein
the case has a prismatic tubular shape,
the electrode assembly has a flat shape, and has a first surface substantially parallel to the sealing plate and facing the sealing plate, a pair of second surfaces each extending in a perpendicular direction from the first surface and each located on a long side of the electrode assembly, and a pair of third surfaces extending in a perpendicular direction from the first surface and each located on a short side of the electrode assembly,
the electrode tab is provided on a side of the first surface,
the side walls of the spacer have a first side wall and a second side wall each extending along the pair of second surfaces,
the outermost layer separator has a first outermost layer separator and a second outermost layer separator along the pair of second surfaces,
the extension portion of the first outermost layer separator is disposed or fixed on an inner side of the first side wall, and
the extension portion of the second outermost layer separator is disposed or fixed on an inner side of the second side wall.

4. The power storage device according to claim 3, wherein
the first electrode and the second electrode are alternately stacked,
the separator includes a portion folded in a meandering manner between the first electrode and the second electrode, and an outer peripheral portion provided to surround an outer side of each of the first electrode and the second electrode, and
as the outer peripheral portion, the first outermost layer separator is disposed on an outermost layer side of one side surface, and the second outermost layer separator is disposed on an outermost layer side of the other side surface.

5. The power storage device according to claim 4, wherein a whole of the separator located between the first electrode and the second electrode and except for the first outermost layer separator and the second outermost layer separator has the extension portion, and a whole of the extension portion is accommodated in an inner space region between the first side wall and the second side wall.

6. The power storage device according to claim 4, wherein the separator is wound one or more turns at an outermost layer.

7. The power storage device according to claim 3, wherein the separator is fixed to the spacer at positions located at four corners of the spacer.

8. The power storage device according to claim 1, wherein
the electrode assembly and the spacer are covered with an insulating sheet, and
the insulating sheet is fixed to the spacer.

9. A method of manufacturing a power storage device, the power storage device including: an electrode assembly having a first electrode, a second electrode, and a separator that is interposed between the first electrode and the second electrode and that includes an outermost layer separator covering an outermost side of the electrode assembly; and a case that accommodates the electrode assembly, wherein
the case has
a case main body that accommodates the electrode assembly and that is provided with an opening, and
a sealing plate that seals the opening,
a spacer is provided between the sealing plate and the electrode assembly,
the spacer has a pair of side walls extending toward the electrode assembly and disposed at a predetermined interval, and
the outermost layer separator of the separator has an extension portion extending from an end portion of each of the first electrode and the second electrode toward the spacer, and the extension portion is disposed on an inner side of each of the side walls or fixed to the side wall, and
in inserting the electrode assembly from the opening into the case main body,
the electrode assembly is inserted into the case main body in a state in which the spacer is disposed on a rear end side of the electrode assembly in an insertion direction of the electrode assembly and the extension portion of at least the outermost layer separator of the separator is disposed on the inner side of each of the side walls or is fixed to the side wall.

10. The method of manufacturing the power storage device according to claim 9, wherein
the electrode assembly has an electrode tab located on a side of the opening of the case main body and electrically connected to an electrode terminal provided on the sealing plate, and
the electrode tab passes through the spacer.

11. The method of manufacturing the power storage device according to claim 10, wherein
the case has a prismatic tubular shape,
the electrode assembly has a flat shape, and has a first surface substantially parallel to the sealing plate and facing the sealing plate, a pair of second surfaces each extending in a perpendicular direction from the first surface and each located on a long side of the electrode assembly, and a pair of third surfaces each extending in a perpendicular direction from the first surface and each located on a short side of the electrode assembly,
the electrode tab is provided on a side of the first surface,
the side walls of the spacer have a first side wall and a second side wall each extending along the pair of second surfaces,
the outermost layer separator has a first outermost layer separator and a second outermost layer separator along the pair of second surfaces, and
the electrode assembly is inserted into the case main body in a state in which the extension portion of the first outermost layer separator is disposed or fixed on an inner side of the first side wall and the extension portion of the second outermost layer separator is disposed or fixed on an inner side of the second side wall.

12. The method of manufacturing the power storage device according to claim 11, wherein
the first electrode and the second electrode are alternately stacked,
the separator includes a portion folded in a meandering manner between the first electrode and the second electrode, and an outer peripheral portion provided to surround an outer side of each of the first electrode and the second electrode, and
as the outer peripheral portion, the first outermost layer separator is disposed on an outermost layer side of one side surface, and the second outermost layer separator is disposed on an outermost layer side of the other side surface.

13. The method of manufacturing the power storage device according to claim 12, wherein a whole of the separator located between the first electrode and the second electrode and except for the first outermost layer separator and the second outermost layer separator has the extension portion, and a whole of the extension portion is accommodated in an inner space region between the first side wall and the second side wall.

14. The method of manufacturing the power storage device according to claim 12, wherein the separator is wound one or more turns at an outermost layer.

15. The method of manufacturing the power storage device according to claim 11, wherein the separator is fixed to the spacer at positions located at four corners of the spacer.

16. The method of manufacturing the power storage device according to claim 9, wherein
the electrode assembly and the spacer are covered with an insulating sheet, and
the insulating sheet is fixed to the spacer.

17. A power storage device comprising: an electrode assembly having a first electrode, a second electrode, and a separator that is interposed between the first electrode and the second electrode and that includes an outermost layer separator covering an outermost side of the electrode assembly; and a case that accommodates the electrode assembly, wherein
the case has
a case main body that accommodates the electrode assembly and that is provided with an opening, and
a sealing plate that seals the opening,
a spacer is provided between the sealing plate and the electrode assembly,
the spacer has a pair of side walls extending toward the electrode assembly and disposed at a predetermined interval,
the outermost layer separator of the separator has an extension portion extending from an end portion of each of the first electrode and the second electrode toward the spacer, and the extension portion is disposed on an inner side of each of the side walls or is fixed to the side wall,
the electrode assembly has an electrode tab located on a side of the opening of the case main body and electrically connected to an electrode terminal provided on the sealing plate,
the electrode tab passes through the spacer,
the case has a prismatic tubular shape,
the electrode assembly has a flat shape, and has a first surface substantially parallel to the sealing plate and facing the sealing plate, a pair of second surfaces each extending in a perpendicular direction from the first surface and each located on a long side of the electrode assembly, and a pair of third surfaces extending in a perpendicular direction from the first surface and each located on a short side of the electrode assembly,
the electrode tab is provided on a side of the first surface,
the side walls of the spacer have a first side wall and a second side wall each extending along the pair of second surfaces,
the outermost layer separator has a first outermost layer separator and a second outermost layer separator along the pair of second surfaces,
the extension portion of the first outermost layer separator is disposed or fixed on an inner side of the first side wall,
the extension portion of the second outermost layer separator is disposed or fixed on an inner side of the second side wall,
the first electrode and the second electrode are alternately stacked,
the separator includes a portion folded in a meandering manner between the first electrode and the second electrode, and an outer peripheral portion provided to surround an outer side of each of the first electrode and the second electrode,
as the outer peripheral portion, the first outermost layer separator is disposed on an outermost layer side of one side surface, and the second outermost layer separator is disposed on an outermost layer side of the other side surface,
a whole of the separator located between the first electrode and the second electrode and except for the first outermost layer separator and the second outermost layer separator has the extension portion, and a whole of the extension portion is accommodated in an inner space region between the first side wall and the second side wall,
the separator is wound one or more turns at an outermost layer, and
the separator is fixed to the spacer at positions located at four corners of the spacer.

18. A method of manufacturing a power storage device, the power storage device including: an electrode assembly having a first electrode, a second electrode, and a separator that is interposed between the first electrode and the second electrode and that includes an outermost layer separator covering an outermost side of the electrode assembly; and a case that accommodates the electrode assembly, wherein
the case has
a case main body that accommodates the electrode assembly and that is provided with an opening, and
a sealing plate that seals the opening,
a spacer is provided between the sealing plate and the electrode assembly,
the spacer has a pair of side walls extending toward the electrode assembly and disposed at a predetermined interval, and
the outermost layer separator of the separator has an extension portion extending from an end portion of each of the first electrode and the second electrode toward the spacer, and the extension portion is disposed on an inner side of each of the side walls or fixed to the side wall,
in inserting the electrode assembly from the opening into the case main body,
the electrode assembly is inserted into the case main body in a state in which the spacer is disposed on a rear end side of the electrode assembly in an insertion direction of the electrode assembly and the extension portion of at least the outermost layer separator of the separator is disposed on the inner side of each of the side walls or is fixed to the side wall,
the electrode assembly has an electrode tab located on a side of the opening of the case main body and electrically connected to an electrode terminal provided on the sealing plate,
the electrode tab passes through the spacer,
the case has a prismatic tubular shape,
the electrode assembly has a flat shape, and has a first surface substantially parallel to the sealing plate and facing the sealing plate, a pair of second surfaces each extending in a perpendicular direction from the first surface and each located on a long side of the electrode assembly, and a pair of third surfaces each extending in a perpendicular direction from the first surface and each located on a short side of the electrode assembly,
the electrode tab is provided on a side of the first surface,
the side walls of the spacer have a first side wall and a second side wall each extending along the pair of second surfaces,
the outermost layer separator has a first outermost layer separator and a second outermost layer separator along the pair of second surfaces,
the electrode assembly is inserted into the case main body in a state in which the extension portion of the first outermost layer separator is disposed or fixed on an inner side of the first side wall and the extension portion of the second outermost layer separator is disposed or fixed on an inner side of the second side wall,
the first electrode and the second electrode are alternately stacked,
the separator includes a portion folded in a meandering manner between the first electrode and the second electrode, and an outer peripheral portion provided to surround an outer side of each of the first electrode and the second electrode,
as the outer peripheral portion, the first outermost layer separator is disposed on an outermost layer side of one side surface, and the second outermost layer separator is disposed on an outermost layer side of the other side surface,
a whole of the separator located between the first electrode and the second electrode and except for the first outermost layer separator and the second outermost layer separator has the extension portion, and a whole of the extension portion is accommodated in an inner space region between the first side wall and the second side wall,
the separator is wound one or more turns at an outermost layer, and
the separator is fixed to the spacer at positions located at four corners of the spacer.
